(19) United States
(12) Patent Application Publication
(10) Pub. No.: US 2003/0036489 A1
(43) Pub. Date: Feb. 20, 2003

(54) Consumable composition comprising perfumed particles and article containing the same

(75) Inventors: Zaiyou Liu, West Chester, OH (US); Toan Trinh, Maineville, OH (US); Kristin Marie Finley, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/137,528

(22) Filed: May 2, 2002

Related U.S. Application Data
(60) Provisional application No. 60/352,829, filed on Jan. 30, 2002.
(60) Provisional application No. 60/288,767, filed on May 4, 2001.

(51) Int. Cl. C11D 1/00

(52) U.S. Cl. 510/100; 510/101; 510/505

(57) ABSTRACT

Perfume delivery compositions and/or consumable compositions that include perfumed particles made of a porous inorganic mineral carrier and a perfume composition absorbed and/or adsorbed thereon. The perfume composition having low levels of certain classes of perfume ingredients that tend to be unstable when incorporated onto or into a porous mineral carrier. Articles of manufacture include the perfume delivery or consumable compositions, and a moisture impermeable container. Optionally, the moisture impermeable container is designed for single use or unit dosing of the compositions. Optionally, the moisture impermeable container is designed for bulk compositions and optionally includes a reclosable or resealable closure.

### CROSS REFERENCE TO RELATED APPLICATIONS

This application claims priority under 35 U.S.C. §119(e) to U.S. Provisional Application Serial Nos. 60/352,829, filed Jan. 30, 2002 (Attorney Docket No.8860P) and 60/288,767, filed May 4, 2001 (Attorney Docket No. 8541P).

### FIELD OF THE INVENTION

The present invention relates to improvements in delivery particles using porous mineral carriers for the delivery of organic agents such as perfume, for use in solid consumable compositions and articles of manufacture comprising said compositions, and methods for selection of compatible agents for use in said delivery particles.

### BACKGROUND OF THE INVENTION

Many consumer products, such as laundry products, home care and cleaning products such as powdered cleaning compositions, and the like, contain a fragrance to provide a pleasant scent. However, in many applications, the perfume does not last long enough to meet the consumer needs. Additionally, in some other applications, such as in laundry products, the perfume is not delivered efficiently to the intended substrate, such as clothing. The industry, therefore, has long searched for an effective perfume carrier system for use in these consumer products to provide long-lasting, storage-stable fragrance in the products, as well as long-lasting fragrance on the target substrate, e.g., the laundered fabrics for laundry detergents and fabric softening compositions, and air for air fresheners.

One perfume carrier system that has received a lot of development effort comprises porous mineral carrier materials such as clay or zeolite materials. The perfume can be adsorbed and/or absorbed into such a porous carrier material to form perfume delivery compositions or perfumed particles that are then incorporated into consumable compositions.

One type of zeolite that has been claimed is Type A or 4A Zeolites with a nominal pore size of approximately 4 Angstrom units, such as are disclosed in U.S. Pat. No. 4,539,135 issued Sep. 3, 1985 to Ramachandran, et al., and U.S. Pat. No. 4,713,193 issued Dec. 15, 1987 to Tai. It is now believed that with Zeolite A or 4A, a perfume is adsorbed onto the zeolite surface with relatively little of the perfume actually absorbing into the zeolite pores.

Combinations of perfumes with larger pore size zeolites X and Y are also taught in the art. East German Patent Publication No. 248,508, published Aug. 12, 1987 relates to perfume dispensers (e.g., an air freshener) containing a faujasite-type zeolite (e.g., zeolite X and Y) loaded with perfumes. The critical molecular diameters of the perfume molecules are said to be from 2 to 8 Angstroms. Also, East German Patent Publication No. 137,599, published Sep. 12, 1979 teaches compositions for use in powdered washing agents to provide thermo-regulated release of perfume. Zeolites A, X and Y are taught for use in these compositions. U.S. Pat. No. 4,539,135, issued Sep. 3, 1985 concerns laundry detergent compositions comprising perfume-containing clay mineral and/or zeolite particles. These teachings are repeated in European Applications Publication No. 535,942 A2, published Apr. 7, 1993, and Publication No. 536,942 A2, published Apr. 14, 1993, and U.S. Pat. No. 5,336,665, issued Aug. 9, 1994 to Garner-Gray, et al.

Zeolites that are useful as perfume carriers because they release perfume during use, are the hydrophilic zeolites. When these zeolites are exposed to ambient air, the zeolites adsorb moisture from the air and become hydrated. Hydrated zeolites are disclosed for use as perfume carriers in, e.g., East German Pat. Pub. No. 137,599 (Example 1), U.S. Pat Nos. 4,539,135 and 4,713,193, and European App. Pub. No. 535,942 A2.

An apparent improvement for zeolite carrier systems is the use of activated or dehydrated zeolites. Activated zeolites contain a much lower level of moisture in their structure. Activated zeolites can be obtained by heating the hydrated zeolites for several hours at a high temperature under atmospheric pressure, as disclosed in, e.g., East German Pat. Pub. No. 137,599 (Example 2), and U.S. Pat. No. 5,336,665, issued Aug. 9, 1994, or by heating at a high temperature under reduced pressure, as disclosed in U.S. Pat. No. 5,648,328, issued Jul. 15, 1997 to Angell, et al., and U.S. Pat No. 5,691,303, issued Nov. 25, 1997 to Pan, et al.

U.S. Pat. No. 5,691,303 discloses that perfumed zeolites are not sufficiently storage-stable for commercial use, such as in granular laundry detergents, due to a premature release of perfume upon moisture absorption after the detergent box has been opened for use. Premature perfume release during storage can also result in an excessive accumulation of the free perfume in the consumable products, causing product odor to be too strong, as is disclosed in U.S. Pat. No. 6,048,830. These issues have prompted a large research effort to find solutions, mainly by searching for a suitable coating material for the perfume-containing zeolite particles, as disclosed in U.S. Pat. No. 5,648,328, issued Jul. 15, 1997 to Angell, et al., U.S. Pat. No. 5,691,303, issued Nov. 25, 1997 to Pan, et al, U.S. Pat. Nos. 5,858,959 issued Jan. 12, 1999, 6,025,319 issued Feb. 15, 2000, 6,221,826 issued Apr. 24, 2001, all issued to Surutzidis, et al., and PCT Publ. WO 01/40430 published on Jun. 7, 2001 to Marin, et al. Another approach to reduce the premature release of perfume is to entrap the perfume molecules in the porous carrier using a “release inhibitor” that is larger than the cross-sectional area of the pore openings of the porous carrier, as is disclosed in U.S. Pat. Nos. 6,048,830 issued Apr. 11, 2000 and 6,245,732, issued Jun. 12, 2001, both to Gallon, et al. All the above solutions are complicated, requiring complex and/or expensive processing. They also reduce the perfume loading capacity of the perfume carrier system, and/or are not satisfactorily effective in sufficiently reducing the premature release of perfume from the carrier.

Furthermore, it is now discovered that surprisingly, many common perfume ingredients are not compatible with the porous mineral carrier materials, such as clay and zeolite, particularly dehydrated or activated zeolites. It is found that some common perfume ingredients are degraded upon incorporation into the porous mineral carrier materials, to form materials that are undesirable and/or not intended in the original perfume compositions.

Accordingly, it is an object of the present invention to provide compositions, and articles of manufacture made therefrom, which comprise stable, free, uncoated, and optionally coated, porous mineral carrier particles containing perfume. The articles are constructed in such a manner that the perfumes are stable in the carrier during storage, and are only released by design during use.

Another object of the present invention is to provide perfume compositions that are stable and not degraded by the porous mineral carriers.

These and other objects and advantages of the present invention will become obvious from the following disclosure.

### SUMMARY OF THE INVENTION

The present invention relates to solid consumable compositions comprising a delivery composition for organic agents, preferably perfume, in the form of perfumed particles comprising:

a) solid, water insoluble, porous mineral carrier, said carrier including a number of pore openings; and

b) agents, preferably perfume compositions, which are releasably incorporated in said carrier, to form a perfumed carrier; wherein said perfume composition comprises less than about 30%, by weight of the perfume composition, of unstable perfume ingredients, preferably selected from the group consisting of allylic alcohol ester, secondary alcohol ester, terttiary alcohol ester, allylic ketone, condensation product of amines and aldehydes, and mixtures thereof, more preferably, allylic alcohol ester, secondary alcohol ester, tertiary alcohol ester, allylic ketone, acetal, ketal, condensation product of amines and aldehydes, and mixtures thereof.

The present invention also relates to solid consumable compositions comprising the perfume delivery composition of the present invention. The present invention also relates to articles of manufacture comprising said consumable compositions packaged in moisture impermeable container, said container optionally having a resealable or reclosable opening.

The present invention also relates to single use solid consumable compositions comprising the perfume delivery composition of the present invention, packaged in moisture impermeable container.

All percentages, ratios and proportions herein are on a weight basis unless otherwise indicated. All documents cited herein are hereby incorporated by reference.

### DETAILED DESCRIPTION OF THE PREFERRED EMBODIMENTS

The present invention relates to solid consumable compositions comprising a delivery composition for organic agents, preferably perfume, in the form of perfumed particles comprising:

a) solid, water insoluble, porous mineral carrier, said carrier including a number of pore openings; and

b) perfume composition which is releasably incorporated in said carrier, to form a perfumed carrier;

wherein said perfume composition comprises less than about 30%, preferably less than about 15%, more preferably less than about 8%, even more preferably less than about 6%, yet even more preferably less than about 3%, and even more preferably less than about 1%, by weight of the perfume composition, of unstable perfume ingredients, preferably selected from the group consisting of allylic alcohol ester, secondary alcohol ester, tertiary alcohol ester, allylic ketone, condensation product of amines and aldehydes, and mixtures thereof, more preferably, allylic alcohol ester, secondary alcohol ester, tertiary alcohol ester, allylic ketone, acetal, ketal, condensation product of amines and aldehydes, and mixtures thereof.

Preferably the porous mineral carrier is selected from the group consisting of zeolite, clay, and mixtures thereof. The preferred zeolites comprise natural or synthetic zeolite having a nominal pore size of at least about 6 Angstroms, preferably at least about 7 Angstroms and a particle size no larger than about 120 microns. The preferred zeolites include Zeolite X or Zeolite Y. The preferred zeolites for use in the present invention are dehydrated and/or activated zeolites.

Typical perfume delivery compositions comprise from about 5% to about 30%, preferably from about 5% to about 20%, by weight, of a perfume comprising less than about 30% of the unstable perfume ingredients described herein.

The present invention also relates to perfume particles that are coated with one or more protective layers of a coating material(s). Furthermore, it also relates to perfume particles that are agglomerated using the coating material.

The present invention also relates to solid consumable compositions comprising the above perfume delivery composition, wherein said consumable composition is in a form selected from a powder, particles, granules, chips, noodles, tablet, sheet, and combinations thereof. Non-limiting examples of solid consumable compositions and products of the present invention include powder, granular detergent and/or fabric conditioning compositions, solid laundry detergent tablets, solid fabric conditioning tablets, fabric conditioning dryer sheets, insect repellent compositions, insecticidal compositions, air freshener compositions, carpet deodorizer compositions, hard surface cleaning compositions, and the like.

Preferred consumable compositions of the present invention include compositions for single use comprising the perfume delivery composition, preferably being packaged in a moisture impermeable container. A preferred moisture impermeable container is a sealed film wrapper.

The present invention also relates to articles of manufacture comprising a consumable composition of the present invention. The consumable composition is preferably packaged in a moisture impermeable container, optionally having a resealable and/or reclosable opening, and optionally comprising a set of instructions associated with the container that directs the consumer to use said composition to provide a long lasting perfume benefit and/or to tightly reseal the container to preserve the long lasting perfume benefit. A preferred container is a film container, e.g., film bag or film pouch, preferably with a resealable opening. Another preferred article comprises one or more single use compositions packaged in a sealed, moisture impermeable film, in a package optionally comprising a set of instructions associated with the container that directs the consumer to use said compositions to provide a long lasting perfume benefit. Preferably, the set of instructions comprises words, pictures, icons, and/or multi-lingual instructions.

### COMPOSITION

Perfume

A wide variety of organic compounds are known for perfume uses, including materials having at least one reactive functional group such as ester, aldehyde, ketone, acetal, ketal, carbon-carbon double bond, and the like. Perfume ingredients according to the present invention can include more than one reactive functional group. More commonly, naturally occurring plant and animal oils and exudates comprising complex mixtures of various chemical components are known for use as perfumes. Non-limiting examples of common perfume ingredients that are useful in consumer products are given in U.S. Pat. No. 5,714,137 issued Feb. 3, 1998 to Trinh, et al. and U.S. Pat. No. 6,048,830 issued Apr. 11, 2000 to Gallon, et al. Non-limiting examples of preferred perfume ingredients suitable for use in perfume compositions of the present invention are adoxal (2,6,10-trimethyl-9-undecen-1-al), amyl acetate, amyl salicylate, anisic aldehyde (4-methoxy benzaldehyde), bacdanol (2-ethyl-4-(2,2,3-trimethyl-3-cyclopenten-1-yl)-2-buten-1-ol), benzaldehyde, benzophenone, benzyl acetate, benzyl salicylate, 3-hexen-1-ol, cetalox (dodecahydro-3A,6,6,9A-tetramethylnaphtho[2,1B]-furan), cis-3-hexenyl acetate, cis-3-hexenyl salicylate, citronellol, coumarin, cyclohexyl salicylate, cymal (2-methyl-3-(para iso propyl phenyl)propionaldehyde), decyl aldehyde, ethyl vanillin, ethyl-2-methyl butyrate, ethylene brassylate, eucalyptol, eugenol, exaltolide (cyclopentadecanolide), florhydral (3-(3-isopropylphenyl) butanal), galaxolide (1,3,4,6,7,8-hexahydro-4,6,6,7,8,8-hexamethylcyclopenta-gamma-2-benzopyrane), gamma decalactone, gamma dodecalactone, geraniol, geranyl nitrile, helional (alpha-methyl-3,4, (methylenedioxy) hydrocinnamaldehyde), heliotropin, hexyl acetate, hexyl cinnamic aldehyde, hexyl salicylate, hydroxyambran (2-cyclododecyl-propanol), hydroxycitronellal, iso E super (7-acetyl-1,2,3,4,5,6,7,8-octahydro-1,1,6,7,tetramethyl naphthalene), iso eugenol, iso jasmone, koavone (acetyl di-isoamylene), lauric aldehyde, lrg 201 (2,4-dihydroxy-3,6-dimethyl benzoic acid methyl ester), lyral (4-(4-hydroxy-4-methyl-pentyl) 3-cylcohexene-1-carboxaldehyde), majantol (2,2-dimethyl-3-(3-methylphenyl)-propanol), mayol (4-(1-methylethyl) cyclohexane methanol), methyl anthranilate, methyl beta naphthyl ketone, methyl cedrylone (methyl cedrenyl ketone), methyl chavicol (1-methyloxy-4,2-propen-1-yl benzene), methyl dihydro jasmonate, methyl nonyl acetaldehyde, musk indanone (4-acetyl-6-tert butyl-1,1-dimethyl indane), nerol, nonalactone (4-hydroxynonanoic acid, lactone), norlimbanol (1-(2,2,6-trimethyl-cyclohexyl)-3-hexanol), P. T. bucinal (2-methyl-3(para tert butylphenyl) propionaldehyde), para hydroxy phenyl butanone, patchouli, phenyl acetaldehyde, phenyl ethyl acetate, phenyl ethyl alcohol, phenyl ethyl phenyl acetate, phenyl hexanol/phenoxanol (3-methyl-5-phenylpentanol), polysantol (3,3-dimethyl-5-(2,2,3-trimethyl-3-cyclopenten-1-yl)-4-penten-2-ol), rosaphen (2-methyl-5-phenyl pentanol), sandalwood, alpha-terpinene, tonalid/musk plus (7-acetyl-1,1,3,4,4,6-hexamethyl tetralin), undecalactone, undecavertol (4-methyl-3-decen-5-ol), undecyl aldehyde, undecylenic aldehyde, vanillin, and mixtures thereof.

Perfumes for incorporation into the porous mineral carriers and for use in the consumable compositions of the present invention can be relatively simple in their compositions or more preferably can comprise highly complex mixtures of natural and/or synthetic chemical ingredients, chosen to provide a desired odor benefit. Perfume compositions herein preferably comprises at least about 6 perfume ingredients, preferably at least about 7 perfume ingredients, more preferably at least about 8 perfume ingredients, even more preferably at least about 9 perfume ingredients, and still more preferably at least about 10 perfume ingredients. Most common perfume ingredients which are derived from natural or synthetic sources can be composed of a multitude of minor components. When each such material is used in the formulation of the preferred perfume compositions of the present invention, it is counted as a single ingredient, for the purpose of defining the invention. Furthermore, in the perfume art, some materials having no odor or very faint odor are used as diluents, or extenders, or fixatives, and/or combinations thereof. Non-limiting examples of these materials are dipropylene glycol, diethyl phthalate, triethyl citrate, isopropyl myristate, and benzyl benzoate. These materials are used for, e.g., diluting and stabilizing some other perfume ingredients. These materials are not counted in the formulation of the preferred perfume compositions of the present invention.

Perfume compositions useful in the compositions and articles of the present invention preferably comprise less than about 100% aldehyde and/or acetal perfume ingredients. In addition, such perfume compositions preferably comprise less than 45% terpinol, by weight of the perfume composition.

Perfume ingredients are more or less volatile, and are perceptible in the vapor phase. The more volatile ingredients can rapidly escape from the consumable composition, or when the perfume is treated on a substrate. In other products, such as laundry products, most of the perfume is lost to the laundry process resulting in only a small amount of perfume being deposited onto the washed fabrics. Laundry products can comprise perfume compositions comprising substantive perfume ingredients that are better retained on fabrics after the washing process. Such substantive perfume ingredients are characterized by having a boiling point equal to or higher than about 250° C. and a ClogP value equal to or greater than about 3, as being disclosed in U.S. Pat No. 5,500,138 issued Mar. 19, 1996 to Bacon, et al. Perfume absorbed onto and/or into a porous carrier to form perfumed particles is another approach to reduce the perfume release and/or perfume loss. However, as noted in the Background of the Invention section above, such perfume particles are not sufficiently stable in storage for many commercial applications, due to a premature release of the perfume from the carrier.

Stable and Unstable Perfume Ingredients

It is now discovered that surprisingly, many common perfume ingredients are not compatible with porous mineral carrier materials, such as clays and zeolites, particularly dehydrated/activated zeolites. It is found that some perfume ingredients are degraded upon incorporation into a porous mineral carrier material, forming materials that are undesirable and/or not intended in the original perfume compositions. Furthermore, some of these ingredients can cause discoloration in some consumable compositions. An unstable perfume ingredient can be identified by loading a liquid perfume composition comprising at least 6 perfume ingredients including the perfume ingredient being studied into a sample of activated/dehydrated zeolite 13X, according to the procedure given hereinbelow, and stored under anhydrous condition for about 24 hours. The perfume ingredients are then extracted with acetone to be recovered as free perfume and analyzed by gas chromatography to determine its stability. A perfume ingredient is characterized as an “unstable perfume ingredient” if at least about 50% of that ingredient, preferably at least 65%, more preferably at least about 80%, and even more preferably at least about 95% of that ingredient is decomposed into other by-products, and not recovered from the extraction.

Non-limiting examples of the unstable perfume ingredients that are not suitable for use in the present invention preferably include ingredients selected from the group consisting of allylic alcohol ester, secondary alcohol ester, tertiary alcohol ester, allylic ketone, condensation product of amines and aldehydes, and mixtures thereof, and more preferably include ingredients selected from the group consisting of allylic alcohol ester, secondary alcohol ester, tertiary alcohol ester, allylic ketone, acetal, ketal, condensation product of amines and aldehydes, and mixtures thereof.

“Allylic alcohol” refers to an alcohol molecule wherein the carbon atom carrying the alcoholic hydroxyl group is covalently bonded to a carbon-carbon double bond in the alpha and beta positions, namely, having the general structure C(OH)—C═C. Non-limiting examples of allylic alcohol ester perfume ingredients include allyl amyl glycolate, allyl anthranilate, allyl benzoate, allyl butyrate, allyl caprate, allyl caproate, allyl cinnamate, allyl cyclohexane acetate, allyl cyclohexane butyrate, allyl cyclohexane propionate, allyl heptoate, allyl nonanoate, allyl salicylate, amyl cinnamyl acetate, amyl cinnamyl formate, cinnamyl formate, cinnamyl acetate, cyclogalbanate, geranyl acetate, geranyl acetoacetate, geranyl benzoate, geranyl cinnamate, methallyl butyrate, methallyl caproate, neryl acetate, neryl butyrate, amyl cinnamyl formate, alpha-methyl cinnamyl acetate, methyl geranyl tiglate, mertenyl acetate, farnesyl acetate, fenchyl acetate, geranyl anthranilate, geranyl butyrate, geranyl iso-butyrate, geranyl caproate, geranyl caprylate, geranyl ethyl carbonate, geranyl formate, geranyl furoate, geranyl heptoate, geranyl methoxy acetate, geranyl pelargonate, geranyl phenylacetate, geranyl phthalate, geranyl propionate, geranyl iso-propoxyacetate, geranyl valerate, geranyl iso-valerate, trans-2-hexenyl acetate, trans-2-hexenyl butyrate, trans-2-hexenyl caproate, trans-2-hexenyl phenylacetate, trans-2-hexenyl propionate, trans-2-hexenyl tiglate, trans-2-hexenyl valerate, beta-pentenyl acetate, alpha-phenyl allyl acetate, prenyl acetate, trichloromethylphenylcarbinyl acetate, and mixtures thereof.

“Secondary alcohol” refers to an alcohol molecule wherein the carbon atom carrying the alcoholic hydroxyl group is covalently bonded to a hydrogen atom and two carbon atoms, namely, having the general structure C—CH(OH)—C. Non-limiting examples of secondary alcohol ester perfume ingredients include secondary-n-amyl acetate, ortho-tertiary-amyl cyclohexyl acetate, isoamyl benzyl acetate, secondary-n-amyl butyrate, amyl vinyl carbinyl acetate, amyl vinyl carbinyl propionate, cyclohexyl salicylate, dihydro-nor-cyclopentadienyl acetate, dihydro-nor-cyclopentadienyl propionate, isobornyl acetate, isobornyl salicylate, isobornyl valerate, flor acetate, frutene, 2-methylbuten-2-ol-4-acetate, methyl phenyl carbinyl acetate, 2-methyl-3-phenyl propan-2-yl acetat, prenyl acetate, 4-tert-butyl cyclohexyl acetate, verdox (2-tert-butyl cyclohexyl acetate), vertenex, (4-tert-butylcyclohexyl acetate), Violiff (carbonic acid 4-cycloocten-1-yl methyl ester), ethenyl-iso-amyl carbinylacetate, fenchyl acetate, fenchyl benzoate, fenchyl-n-butyrate, fenchyl isobutyrate, laevo-menthyl acetate, dl-menthyl acetate, menthyl anthranilate, menthyl benzoate, menthyl-iso-butyrate, menthyl formate, laevo-menthyl phenylacetate, menthyl propionate, menthyl salicylate, menthyl-iso-valerate, cyclohexyl acetate, cyclohexyl anthranilate, cyclohexyl benzoate, cyclohexyl butyrate, cyclohexyl-iso-butyrate, cyclohexyl caproate, cyclohexyl cinnamate, cyclohexyl formate, cyclohexyl heptoate, cyclohexyl oxalate, cyclohexyl pelargonate, cyclohexyl phenylacetate, cyclohexyl propionate, cyclohexyl thioglycolate, cyclohexyl valerate, cyclohexyl-iso-valerate, methyl amylacetate, methyl benzyl carbinyl acetate, methyl butyl cyclohexanyl acetate, 5-methyl-3-butyl-tetrahydropyran-4-yl acetate, methyl citrate, methyl-iso-campholate, 2-methyl cyclohexyl acetate, 4-methyl cyclohexyl acetate, 4-methyl cyclohexyl methyl carbinyl acetate, methyl ethyl benzyl carbinyl acetate, 2-methylheptanol-6-acetate, methyl heptenyl acetate, alpha-methyl-n-hexyl carbinyl formate, methyl-2-methylbutyrate, methyl nonyl carbinyl acetate, methyl phenyl carbinyl acetate, methyl phenyl carbinyl anthranilate, methyl phenyl carbinyl benzoate, methyl phenyl carbinyl-n-butyrate, methyl phenyl carbinyl-iso-butyrate, methyl phenyl carbinyl caproate, methyl phenyl carbinyl caprylate, methyl phenyl carbinyl cinnamate, methyl phenyl carbinyl formate, methyl phenyl carbinyl phenylacetate, methyl phenyl carbinyl propionate, methyl phenyl carbinyl salicylate, methyl phenyl carbinyl-iso-valerate, 3-nonanyl acetate, 3-nonenyl acetate, nonane diol-2:3-acetate, nonynol acetate, 2-octanyl acetate, 3-octanyl acetate, n-octyl acetate, secondary-octyl-iso-butyrate, beta-pentenyl acetate, alpha-phenyl allyl acetate, phenylethyl methyl carbinyl-iso-valerate, phenylethyleneglycol diphenylacetate, phenylethyl ethnyl carbinyl acetate, phenylglycol diacetate, seconday-phenylglycol monoacetate, phenylglycol monobenzoate, isopropyl caprate, isopropyl caproate, isporppyl caprylate, isopropyl cinnamate, para-isopropyl cyclohexanyl acetate, propylglycol diacetate, propyleneglycol di-isobutyrate, propyleneglycol dipropionate, isopropyl-n-heptoate, isopropyl-n-hept-1-yne carbonate, isopropyl pelargonate, isopropyl propionate, isopropyl undecylenate, isopropyl-n-valerate, isopropyl-n-valerate, isopropyl-iso-valerate, isopropyl sebacinate, isopulegyl acetate, isopulegyl acetoacetate, isopulegyl isobutyrate, isopulegyl formate, thymyl propionate, alpha-2,4-trimethyl cyclohexane methylacetate, trimethyl cyclohexyl acetate, vanillin triacetate, vanillylidene diacetate, vanillyl vanillate, and mixtures thereof.

“Teriary alcohol” refers to an alcohol molecule wherein the carbon atom carrying the alcoholic hydroxyl group is covalently bonded to three other carbon atoms, namely, having the general structure

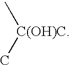

Non-limiting examples of tertiary alcohol ester include tertiary-amyl acetate, caryophyllene acetate, cedrenyl acetate, cedryl acetate, dihydromyrcenyl acetate, dihydroterpinyl acetate, dimethyl benzyl carbinyl acetate, dimethyl benzyl carbinyl isobutyrate, dimethyl heptenyl acetate, dimethyl heptenyl formate, dimethyl heptenyl propionate, dimethyl heptenyl-iso-butyrate, dimethyl phenylethyl carbinyl acetate, dimethyl phenylethyl carbinyl-iso-butyrate, dimethyl phenylethyl carbinyl-iso-valerate, dihydro-nor-dicyclopentadienyl acetate, dimethyl benzul carbinyl butyrate, dimethyl benzyl carbinyl formate, dimethyl benzyl carbinyl propionate, dimethyl phenylethyl carbinyl-n-butyrate, dimethyl phenyletyl carbinyl formate, dimethyl phenylethyl carbinyl propionate, elemyl acetate, ethinyl cyclohexylacetate, eudesmyl acetate, eugenyl cinnamate, eugenyl formate, iso-eugenyl formate, eugenyl phenylacetate, isoeudehyl phenylacetate, guaiyl acetate, hydroxycitronellyl ethylcarbonate, linallyl acetate, linallyl anthranilate, linallyl benzoate, linallyl butyrate, linallyl iosbutyrate, linallyl carproate, linallyl caprylate, linallyl cinnamate, linallyl citronellate, linallyl formate, linallyl heptoate, linallyl-N-methylanthranilate, linallyl methyltiglate, linallyl pelargonate, linallyl phenylacetate, linallyl propionate, linallyl pyruvate, linallyl salicylate, linallyl-n-valerate, linallyl-iso-valerate, methylcyclopentenolone butyrate, methyl cyclopentenolone propionate, methyl ethyl phenyl carbinyl acetate, methyl heptin carbonate, methyl nicotinate, myrcenyl acetate, myrcenyl formate, myrcenyl propionate, cis-ocimenyl acetate, phenyl salicylate, terpinyl acetate, terpinyl anthranilate, terpinyl benzoate, terpinyl-n-butyrate, terpinyl-iso-butyrate, terpinyl cinnamate, terpinyl formate, terpinyl phenylacetate, terpinyl propionate, terpinyl-n-valerate, terpinyl-iso-valerate, tributyl acetylcitrate, and mixtures thereof.

Some alcohols of the unstable alcohol ester perfume ingredients can be both allylic and secondary, or both allylic and tertiary. Non-limiting examples of these ingredients are amyl vinyl carbinyl acetate, amyl vinyl carbinyl propionate, hexyl vinyl carbinyl acetate, 3-nonenyl acetate, 4-hydroxy-2-hexenyl acetate, linallyl anthranilate, linallyl benzoate, linallyl butyrate, linallyl iosbutyrate, linallyl carproate, linallyl caprylate, linallyl cinnamate, linallyl citronellate, linallyl formate, linallyl heptoate, linallyl-N-methylanthranilate, linallyl methyltiglate, linallyl pelargonate, linallyl phenylacetate, linallyl propionate, linallyl pyruvate, linallyl salicylate, linallyl-n-valerate, linallyl-iso-valerate, myrtenyl acetate, nerolidyl acetate, nerolidyl butyrate, beta-pentenyl acetate, alpha-phenyl allyl acetate, and mixtures thereof.

“Allylic ketone” refers to a ketone molecule wherein the ketone functional group is covalently bonded to a carbon-carbon double bond in the alpha and beta positions, namely, having a general structure C—C(═O)—C═C. Non-limiting examples of allylic ketone perfume ingredients include acetyl furan, allethrolone, allyl ionone, allyl pulegone, amyl cyclopentenone, benzylidene acetone, benzylidene acetophenone, alpha iso methyl ionone, 4-(2,6,6-trimetyl-1-cyclohexen-1-yl)-3-buten-2-one), beta damascone (1-(2,6,6-trimethylcyclohexen-1-yl)-2-buten-1-one), damascenone (1-(2,6,6-trimethyl-1,3-cyclohexadien-1-yl)-2-buten-1-one), delta damascone (1-(2,6,6-trimethyl-3-cyclo-hexen-1-yl)-2-buten-1-one), alpha ionone (4-(2,6,6-trimethyl-1-cyclohexenyl-1-yl)-3-buten-2-one), beta ionone (4-(2,6,6-trimethyl-1-cyclohexen-1-yl)-3-2one), gamma methyl ionone (4-(2,6,6-trimethyl-2-cyclohexyl-1-yl)-3-methyl-3-buten-2-one), pulegone, and mixtures thereof.

“Acetal” refers to an acetal molecule wherein the aldehyde functional group is covalently bonded to two oxygen atoms of two hydroxyl groups at the same carbonyl carbon, namely, having a general structure C—CH(OC)₂. Non-limiting examples of acetal perfume ingredients include acetaldehyde-benzyl-beta-methoxyethyl acetal, acetaldehyde-di-iso-amyl acetal, acetaldehyde-di-pentandeiol acetal, acetaldehyde-di-n-propyl acetal, 10 acetaldehyde-ethyl-trans-3-hexenyl acetal, acetaldehyde-phenylethyleneglycol acetal, acetaldehyde phenylethyl-n-propylacetal, cinnamic aldehyde dimethyl acetal, acetaldehyde-benzyl-beta-methoxyethyl acetal, acetaldehyde-di-iso-amylacetal, acetaldehyde diethylacetal, acetaldehyde-di-cis-3-hexenyl acetal, acetaldehyde-di pentanediol acetal, acetaldehyde-di-n-propyl acetal, acetaldehyde-ethyl-trans-3-hexenyl acetal, acetaldehyde-phenylethyleneglycol acetal, acetaldehyde phenylethyl-n-propylacetal, acetylvanillin dimethylacetal, alpha-amylcinnamic aldehyde-di-iso-propyl acetal, p-tertiary-amyl phenoxy acetaldehyde diethylacetal, anisaldehyde-diethylacetal, anisaldehyde-dimethylacetal, iso-apiole, benzaldehyde diethylacetal, benzaldehyde-di-(ethyleneglycol monobutylether) acetal, benzaldehyde dimethylacetal, benzaldehyde ethyleneglycolacetal, benzaldehyde glyceryl acetal, benzaldehydepropyleneglycol acetal, cinnamic aldehyde diethyl acetal, citral diethyl acetal, citral dimethyl acetal, citral propyleneglycol acetal, alpha-methylcinnamic aldehyde diethylacetal, alpha-cinnamic aldehyde dimethylacetal, phenylacetaldehyde-2,3-butyleneglycol acetal, phenylacetaldehyde citronellyl methyl acetal, phenylacetaldehyde diallylacetal, phenylacetaldehyde diamylacetal, phenylacetaldehyde dibenzylacetal, phenylacetaldehyde dibutyl acetal, phenylacetaldehyde diethylacetal, phenylacetaldehyde digeranylacetal, phenylacetaldehyde dimethylacetal, phenylacetaldehyde ethyleneglycol acetal, phenylacetalde glycerylacetal, citronellal cyclomonoglycolacetal, citronellal diethylacetal, citronellal dimethylacetal, citronellal diphenylethyl acetal, geranoxyacetaldehyde diethylacetal, and mixtures thereof.

“Ketal” refers to a ketal molecule wherein the carbonyl functional group of a ketone is covalently bonded to two oxygen atoms of two hydroxyl groups at the same carbonyl carbon, namely, having a general structure CC(OC)₂C. Non-limiting examples of acetal perfume ingredients include acetone diethylkatal, acetone dimethylketal, acetophenone diethyl ketal, methyl amyl catechol ketal, methyl butyl catechol ketal, and mixtures thereof.

Non-limiting examples of perfume ingredients being condensation products of amines and alhehydes, and not being preferred in the perfume compositions of the present invention include anisaldehyde-methylanthranilate, aurantiol (hydroxycitronellal methylanthranilate), verdantiol (4-tert-butyl-alpha-methyldihydrocinnamaldehyde methyl anthranilate), vertosine (2,4-dimethyl-3-cyclohexene carbaldehyde), hydroxycitronellal ethylanthranilate, hydroxycitronellal linallylanthranilate, methyl-N-(4-(4-hydroxy-4-methylpentyl)-3-cyclohexenyl-methylidene)-anthranilate, methylnaphthylketone-methylanthranilate, methyl nonyl acetaldehyde methylanthranilate, methyl-N-(3,5,5-trimethylhexylidene) anthranilate, vanillin methylanthranilate, and mixtures thereof.

While not wishing to be bound by theory, it is believed that the porous mineral carriers of the present invention exert a catalytic effect that promotes decomposition, degradation and/or a polymerization of these particular perfume ingredients.

The perfume compositions that are suitable for use in the present invention typically comprises less than about 30%, preferably less than about 15%, more preferably less than about 7%, even more preferably less than about 5%, yet even more preferably less than about 3%, and even more preferably less than about 1%, by weight of the perfume composition, of unstable perfume ingredients, preferably selected from the group consisting of allylic alcohol ester, secondary alcohol ester, tertiary alcohol ester, allylic ketone, condensation product of amines and aldehydes, and mixtures thereof, more preferably, allylic alcohol ester, secondary alcohol ester, tertiary alcohol ester, allylic ketone, acetal, ketal, condensation product of amines and aldehydes, and mixtures thereof.

A “stable” perfume ingredient can be loaded into activated/dehydrated zeolite 13X in the same manner without substantial degradation, with typically at least about 50%, preferably at least 65%, more preferably at least about 80%, and even more preferably at least about 95% of that ingredient not decomposed into other by-products. A perfume molecule is also considered as “stable” when it is isomerized in the zeolite loading process into another structure with the same molecular weight. Non-limiting examples of such stable perfume ingredients include alpha-pinene and beta-pinene.

Thus, the perfume compositions that are suitable for use in the present invention typically comprises at least about 70%, preferably at least about 85%, more preferably at least about 93%, even more preferably at least about 95%, yet even more preferably at least about 97%, and even more preferably at least about 99%, by weight of the perfume composition, of stable perfume ingredients.

Porous mineral carriers provide an advantageous benefit in that they can retain perfume ingredients for a slow release, including non-substantive ingredients. Therefore, preferably, perfume compositions that are incorporated into the porous mineral carrier, for use in the compositions and articles of the present invention comprise at least about 30%, preferably at least about 50%, more preferably at least about 65%, of non-substantive perfume ingredients which are characterized by having a boiling point equal to or lower than about 250° C. and/or having a ClogP being equal or smaller than about 3.

Non-limiting examples of such non-substantive perfume ingredients include amyl acetate, amyl propionate, anethol, anisic aldehyde, anisole, benzaldehyde, benzyl acetate, benzyl acetone, benzyl alcohol, benzyl butyrate, benzyl formate, benzyl iso valerate, benzyl propionate, camphor gum, carvacrol, laevo-carveol, d-carvone, laevo-carvone, citral (neral), citronellol, citronellyl acetate, citronellyl isobutyrate, citronellyl nitrile, citronellyl propionate, para-cresol, para-cresyl methyl ether, cyclohexyl ethyl acetate, cuminic alcohol, cuminic aldehyde, cyclal C (3,5-dimethyl-3-cyclohexene-1-carboxaldehyde), para-cymene, decyl aldehyde, dimethyl benzyl carbinol, dimethyl octanol, diphenyl oxide, dodecalactone, ethyl acetate, ethyl aceto acetate, ethyl amyl ketone, ethyl benzoate, ethyl butyrate, ethyl hexyl ketone, ethyl phenyl acetate, eucalyptol, eugenol, fenchyl alcohol, geraniol, geranyl nitrile, hexenol, beta gamma hexenol, hexenyl acetate, cis-3-hexenyl acetate, hexenyl isobutyrate, cis-3-hexenyl tiglate, hexyl acetate, hexyl formate, hexyl neopentanoate, hexyl tiglate, hydratropic alcohol, hydroxycitronellal, indole, alpha-irone, isoamyl alcohol, isobutyl benzoate, isomenthone, isononyl acetate, isononyl alcohol, isobutyl quinoline, isomenthol, para-isopropyl phenylacetaldehyde, isopulegol, isopulegyl acetate, isoquinoline, cis-jasmone, lauric aldehyde (dodecanal), ligustral (2,4-dimethyl-3-cyclohexene-1-carboxaldehyde), linalool, linalool oxide, menthone, methyl acetophenone, para-methyl acetophenone, methyl amyl ketone, methyl anthranilate, methyl benzoate, methyl benzyl acetate, methyl chavicol, methyl eugenol, methyl heptenone, methyl heptine carbonate, methyl heptyl ketone, methyl hexyl ketone, methyl nonyl acetaldehyde, methyl octyl acetaldehyde, methyl salicylate, myrcene, neral, nerol, gamma-nonalactone, nonyl acetate, nonyl aldehyde, allo-ocimene, octalactone, octyl alcohol (octanol-2), octyl aldehyde, (d-limonene), phenoxy ethanol, phenyl acetaldehyde, phenyl ethyl acetate, phenyl ethyl alcohol, phenyl ethyl dimethyl carbinol, propyl butyrate, rose oxide, 4-terpinenol, alpha-terpineol, terpinolene, tonalid (6-acetyl-1,1,3,4,4,6-hexamethyl tetrahydronaphthalene), undecenal, veratrol (ortho-dimethoxybenzene), coumarin, dihydroeuginol, dihydro isojasmonate, ethyl cinnamate, ethyl maltol, ethyl-2-methyl butyrate, ethyl salicylate, ethyl vanillin, eugenyl acetate, eugenyl formate, eugenyl methyl ether, fructone, geranyl oxyacetaldehyde, heliotropin, hinokitiol, hydroxycitronellol, indole, isoeugenol, isoeugenyl acetate, isomenthone, lyral, methyl cinnamate, methyl dihydrojasmonate, methyl isobutenyl tetrahydropyran, methyl beta naphthyl ketone, para-anisic aldehyde, para hydroxy phenyl butanone, para-methoxy acetophenone, para methyl acetophenone, phenoxyethyl propionate, phenylacetaldehyde diethyl ether, phenylethyl oxyacetaldehyde, vanillin, and mixtures thereof.

The perfume composition of the present invention can additionally comprise perfume ingredients with low odor detection threshold. The odor detection threshold of an odorous material is the lowest vapor concentration of that material that can be olfactorily detected. The odor detection threshold and some odor detection threshold values are discussed in, e.g., “Standardized Human Olfactory Thresholds”, M. Devos, et al, IRL Press at Oxford University Press, 1990, and “Compilation of Odor and Taste Threshold Values Data”, F. A. Fazzalari, editor, ASTM Data Series DS 48A, American Society for Testing and Materials, 1978, both of said publications being incorporated by reference. The use of small amounts of perfume ingredients that have low odor detection threshold values can improve perfume odor character, and are especially useful in the compositions of the present invention. These materials can be present at low levels in the perfume compositions of the present invention, typically less than about 20% by weight of the total perfume compositions of the present invention.

Nonlimiting examples of stable perfume ingredients that have a significantly low detection threshold, useful in the composition of the present invention, are, ambrox (1,5,5,9-tetramethyl-1,3-oxatricyclotridecane), anethole, bacdanol (2-ethyl-4-(2,2,3-trimethyl-3-cyclopenten-1-yl)-2-buten-1-ol), benzyl acetone, benzyl salicylate, butyl anthranilate, calone, cetalox (2-ethyl-4-(2,2,3-trimethyl-3-cyclopenten-1-yl)-2-buten-1-ol), cinnamic alcohol, coumarin, Cyclal C (3,5-dimethyl-3-cyclohexene-1-carboxaldehyde), cymal (2-methyl-3-(para iso propylphenyl)propionaldehyde), 4-decenal, dihydro isojasmonate, gamma-dodecalactone, ebanol, ethyl anthranilate, ethyl-2-methyl butyrate, ethyl vanillin, eugenol, florhydral (3-(3-isopropylphenyl)butanol), fructone (ethyl-2-methyl-1,3-dioxolane-2-acetate), heliotropin, herbavert (3,3,5-trimethylcyclohexyl-ethyl ether), cis-3-hexenyl salicylate, indole, iso cyclo citral, isoeugenol, alpha-isomethylionone, keone, lilial (para-tertiary butyl alpha-methyl hydrocinnamic aldehyde), linalool, lyral (4-(4-hydroxy-4-methyl-pentyl)3-cylcohexene-1-carboxaldehyde), methyl heptine carbonate, methyl anthranilate, methyl dihydrojasmonate, methyl isobutenyl tetrahydropyran, methyl beta naphthyl ketone, methyl nonyl ketone, beta naphthol methyl ether, nerol, para-anisic aldehyde, para hydroxy phenyl butanone, phenyl acetaldehyde, gamma-undecalactone, undecylenic aldehyde, vanillin, and mixtures thereof. Some of the low odor detection perfume ingredients are also non-substantive perfume ingredients.

In a preferred embodiment, the perfume composition of the present invention does not consist of 0.2% allyl amyl glycolate, 0.31% damascenone, 0.51% decyl aldehyde, 15.27% dihydro iso jasmonate, 1.02% helional, 14.97% ionone gamma methyl, 20.37% linalool, 1.02% myrcene, 15.27% p.t. bucinal, 0.51% para methyl acetophenone, 20.37% phenyl ethyl alcohol, and 10.18% undecavertol, by weight of the perfume composition. In another preferred embodiment, the perfume composition of the present invention does not consist of 10% benzyl salicylate, 5% coumarin, 2% ethyl vanillin, 10% ethylene brassylate, 15% galaxolide, 20% hexyl cinnamic aldehyde, 10% gamma methyl ionone, 15% lilial, 5% methyl dihydrojasmonate, 5% patchouli, and 3% tonalid.

A zeolite carrier having perfume incorporated into the zeolite is referred to as a perfumed particle. The total “zeolite payload” refers to the maximum amount of perfume which can be incorporated into the zeolite carrier. The zeolite payload is less than about 20%, typically less than about 18.5%, by weight of the loaded particle, given the limits on the pore volume of the zeolite. It is to be recognized, however, that the perfumed particles may comprise perfume in an amount that exceeds the payload level, because of excess perfume that is not incorporated into the zeolite pores. Therefore, the perfumed particles of the present invention particles may comprise more than 20% by weight of perfume.

The compositions and articles of the present invention can additionally comprise free perfume that is not incorporated in the porous mineral carriers. Free perfume can comprise stable and/or unstable perfume ingredients. As disclosed hereinabove, in the context of fabric care compositions such as laundry detergent and/or fabric conditioning compositions, a substantial amount of the free perfume that is added to the wash and/or the rinse cycle is lost with the water and in the subsequent drying cycle. It is therefore preferable that at least about 25%, more preferably at least about 50%, and even more preferably at least about 70%, by weight of free perfume when present, is composed of substantive ingredients that tend to remain on fabrics after the laundry washing and drying process. Substantive perfume ingredients are characterized by having a boiling point equal to or higher than about 250° C. and a ClogP value equal to or greater than about 3, as disclosed in U.S. Pat No. 5,500,138 issued to Bacon, et al. Non-limiting examples of the preferred substantive perfume ingredients for use in the free perfume compositions of the present invention are listed as “enduring perfume ingredients” in PCT Publication WO 01/85888 published Nov. 15, 2001.

Optionally, the compositions and articles of the present invention can comprise one or more pro-fragrances, pro-perfumes, pro-accords, and mixtures thereof, known collectively as “pro-fragrances”. Preferably the pro-fragrances are not incorporated into the dehydrated/activated porous mineral carriers. Non-limiting examples of pro-fragrances include acetal pro-fragrances, ketal pro-fragrances, ester pro-fragrances, hydrolysable inorganic-organic pro-fragrances, and mixtures thereof. The preferred pro-fragrances are described with more details in PCT Publication WO 01/85888 published Nov. 15, 2001.

Optionally, free, stable and/or unstable perfume ingredients, including non-substantive perfume ingredients can be incorporated or encapsulated in other types of perfume carriers, for use in the compositions and articles of the present invention. Thus, the perfume can be encapsulated in the form of molecular encapsulation, such as inclusion in a complex with cyclodextrin, coacevate microencapsulation wherein the perfume droplet is enclosed in a solid wall material, and “cellular matrix” encapsulation wherein solid particles contain perfume droplets stably held in cells or perfume is embedded in, e.g., starch or sugar matrix. These preferred optional perfume carriers, which can be useful in the present invention, are disclosed in PCT Publication WO 01/85888 published Nov. 15, 2001.

Following are non-limiting examples of suitable perfume compositions of the present invention:

Perfume A

| Perfume Ingredients | Wt. % |
|---|---|
| Amyl salicylate | 1 |
| Anisic aldehyde | 1 |
| Citral | 4 |
| Citronellol | 5 |
| Citronellyl nitrile | 3 |
| para Cymene | 2 |
| Decyl aldehyde | 1 |
| Dihydro myrcenol | 15 |
| Geranyl nitrile | 3 |
| beta gamma Hexenol | 0.3 |
| cis-3-Hexenyl acetate | 0.2 |
| Hexyl cinnamic aldehyde | 5 |
| Hexyl salicylate | 3 |
| alpha-Ionone | 2 |
| cis-Jasmone | 1 |
| Linalool | 8 |
| Linalyl acetate | 5 |
| gamma-Methyl ionone | 3 |
| Myrcene | 1.5 |
| Nerol | 3 |
| Orange terpenes | 15 |
| P.T. Bucinal | 5 |
| Patchouli | 1 |
| Phenyl hexanol | 5 |
| beta-Pinene | 3 |
| alpha-Terpineol | 4 |
| Total | 100 |

Perfume A comprises about 10% by weight of unstable perfume ingredients.

Perfume B

| Perfume Ingredients | Wt. % |
|---|---|
| Aurantiol | 3 |
| Benzophenone | 3 |
| Citronellol | 15 |
| Citronellyl nitrile | 3 |
| Decyl aldehyde | 1 |
| Dihydro myrcenol | 5 |
| Dimethyl octanol | 5 |
| Diphenyl oxide | 1 |
| Geraniol | 7 |
| Geranyl acetate | 3 |
| Geranyl formate | 3 |
| Hexyl cinnamic aldehyde | 10 |
| alpha-Ionone | 3 |
| Isobornyl acetate | 4 |
| gamma-Methyl ionone | 4 |
| P. T. Bucinal | 10 |
| Phenyl ethyl alcohol | 15 |
| Terpineol | 5 |
| Total | 100 |

Perfume B comprises about 20% by weight of unstable perfume ingredients.

Perfume C

| Perfume Ingredients | Wt. % |
|---|---|
| Bisabolene | 3 |
| Camphene | 1 |
| Caryophyllene | 1 |
| para-Cymene | 1 |
| Eucalyptol | 1.5 |
| Fenchyl alcohol | 1 |
| Geranyl acetate | 2 |
| d-Limonene | 49 |
| Linalool | 3 |
| Myrcene | 2 |
| alpha-Pinene | 1.5 |
| beta-Pinene | 2 |
| Terpinene-4-ol | 2 |
| Terpineol | 10 |
| Terpinolene | 20 |
| Total | 100 |

Perfume C comprises about 10% by weight of unstable perfume ingredients.

Perfume D

| Perfume Ingredients | Wt. % |
|---|---|
| Citral | 4 |
| Frutene | 15 |
| d-Limonene | 50 |
| Linalyl Acetate | 6 |
| Methyl Dihydrojasmonate | 18 |
| alpha-Pinene | 4 |
| beta-Pinene | 3 |
| Total | 100 |

Perfume D comprises about 21% by weight of unstable perfume ingredients.

Perfume E

| Perfume Ingredients | Wt. % |
|---|---|
| Camphor gum | 0.5 |
| para-Cymene | 0.5 |
| Dihydro myrcenol | 1 |
| Dihydro terpineol | 2.5 |
| Dimethyl benzyl carbinol | 1 |
| Dimetol | 1.5 |
| Eucalyptol | 1 |
| Fenchyl alcohol | 1.5 |
| Isononyl alcohol | 0.5 |
| Tetrahydro linalool | 45 |
| Tetrahydro myrcenol | 44 |
| Verdox | 1 |
| Total | 100 |

Perfume E comprises about 1% by weight of unstable perfume ingredients.

Perfume F

| Perfume Ingredients | Wt. % |
|---|---|
| Benzyl Propionate | 2 |
| Citral | 3 |
| Citronellyl nitrile | 2 |
| Decyl aldehyde | 0.5 |
| Dihydro myrcinol | 10 |
| Eucalyptol | 2 |
| Fenchyl alcohol | 0.5 |
| Flor acetate | 7 |
| Frutene | 5 |
| Geranyl nitrile | 3 |
| beta gamma Hexenol | 0.5 |
| Linalool | 7 |
| Linalyl acetate | 5 |
| Methyl dihydro jasmonate | 5 |
| Octyl aldehyde | 0.5 |
| Orange terpenes | 30 |
| para-Cymene | 1.5 |
| Phenyl hexanol | 5 |
| alpha-Pinene | 2.5 |
| alpha-Terpineol | 2 |
| Terpinyl acetate | 2 |
| Tetrahydro linalool | 3 |
| Verdox | 1 |
| Total | 100 |

Perfume F comprises about 20% by weight of unstable perfume ingredients.

Perfumes G and H

| | G | H |
|---|---|---|
| Perfume Ingredients | Wt. % | Wt. % |
| Amyl salicylate | 8 | — |
| Benzyl acetate | 8 | 8 |
| Benzyl Salicylate | — | 2 |
| Citronellol | 7 | 25 |
| Dihydromyrcenol | 2 | — |
| Eugenol | 4 | — |
| Flor acetate | 8 | — |
| Galaxolide | 1 | — |
| Geraniol | 5 | — |
| Hexyl cinnamic aldehyde | 2 | — |
| Hydroxycitronellal | 3 | — |
| Lilial | 2 | — |
| Linalool | 6 | 9 |
| Linalyl acetate | 5 | — |
| Lyral | 3 | — |
| Methyl dihydrojasmonate | 3 | — |
| Nerol | 2 | — |
| Orange terpenes | 7 | 10 |
| Phenoxy ethyl propionate | — | 3 |
| Phenylethyl acetate | 5 | 15 |
| Phenylethyl alcohol | 7 | 15 |
| alpha-Terpineol | 5 | 13 |
| alpha-Terpinene | 5 | — |
| Tetrahydromyrcenol | 2 | — |
| Total | 100 | 100 |

Perfume G comprises about 13% by weight of unstable perfume ingredients. Perfume H does not comprises an appreciable amount of unstable perfume ingredients.

Porous Mineral Carriers

A preferred porous carrier of the present invention is a porous zeolite having a multitude of pore openings. The term “zeolite” used herein refers to a crystalline aluminosilicate material. The structural formula of a zeolite is based on the crystal unit cell, the smallest unit of structure represented by

M_{m/n}[(AlO₂)ₘ(SiO₂)_{y}].xH₂O

where n is the valence of the cation M, x is the number of water molecules per unit cell, m and y are the total number of tetrahedra per unit cell, and y/m is about 1 to about 100. Most preferably, y/m is about 1 to about 5. The cation M can be Group IA and Group IIA elements, such as sodium, potassium, magnesium, and calcium.

A suitable class of zeolites for use in the present invention is Zeolite A and zeolite 4A.

The zeolite that is preferred for use herein is a faujasite-type zeolite, including Type X Zeolite or Type Y Zeolite, both with a nominal pore size of about 8 Angstrom units, typically in the range of from about 7.4 to about 10 Angstrom units.

The aluminosilicate zeolite materials useful in the practice of this invention are commercially available. Methods for producing X and Y-type zeolites are well-known and available in standard texts. Preferred synthetic crystalline aluminosilicate materials useful herein are available under the designation Type X or Type Y.

For purpose of illustration, non-limiting examples of the preferred Type X zeolites include:

Na₈₆[AlO₂]₈₆(SiO₂)₁₀₆].xH₂O, (I)

K₈₆[AlO₂]₈₆(SiO₂)₁₀₆].xH₂O, (II)

Ca₄₀Na₆[AlO₂]₈₆(SiO₂)₁₀₆].xH₂O, (III)

Sr₂₁Ba₂₂[AlO₂]₈₆(SiO₂)₁₀₆].xH₂O, (IV)

and mixtures thereof, wherein x is from about 0 to about 276. Zeolites of formula (I) and (II) have a nominal pore size or opening of 8.4 Angstroms units. Zeolites of formula (III) and (IV) have a nominal pore size or opening of 8.0 Angstroms units.

Similarly, non-limiting examples of the preferred Type Y zeolites include:

Na₅₆[AlO₂]₅₆.(SiO₂)₁₃₆].xH₂O, (V)

K₅₆[AlO₂]₅₆.(SiO₂)₁₃₆].xH₂O (VI)

and mixture thereof, wherein x is from about 0 to about 276. Zeolites of formula (V) and (VI) have a nominal pore size or opening of 8.0 Angstroms units.

The zeolites used in the present invention are in particle form having an average particle size from about 0.5 microns to about 120 microns, preferably from about 0.5 microns to about 30 microns, as measured by standard particle size analysis technique.

More information about these and other zeolites, the preferred embodiments, including non-limiting examples of different zeolite types are given in U.S. Pat. No. 5,691,303 issued Nov. 25, 1997 to Pan, et al., U.S. Pat No. 6,221,826 issued Apr. 24, 2001 to Surutzidis, et al., and U.S. Pat. No. 6,245,732 issued Jun. 12, 2001 to Gallon, et al.

Hydrated zeolites are suitable for the compositions of the present invention. Preferred zeolites are dehydrated/activated zeolites. The Type X or Type Y Zeolites to be used herein preferably contain less than about 10% desorbable water, more preferably less than about 8% desorbable water, and even more preferably less than about 5% desorbable water. Activated zeolites can be obtained by heating the zeolites to a high temperature under normal atmospheric pressure, e.g., to 450° C. as disclosed in East German Patent Publication No. 248,508, published Aug. 12, 1987, and to about 150-350° C. for at least about 12 hours as disclosed in U.S. Pat No. 5,691,303 issued Nov. 25, 1997, or heating the zeolites to a high temperature under reduced pressure, e.g., from about 0.001 to about 20 Torr, as disclosed in U.S. Pat No. 5,691,303 issued Nov. 25, 1997.

Clay also can be a useful porous carrier for use in the present invention. The clay minerals which are useful herein include a wide variety of materials, included among which are smectite-type clays such as bentonite, montmorillonite; kaolinite, metakaolin; attapulgite, and mixtures thereof. These and other preferred clays are disclosed with more details in U.S. Pat. No. 4,539,135 issued Sep. 3, 1985.

Incorporation of Perfume in Zeolite—The Type X or Type Y Zeolites suitable herein preferably contain less than about 10% desorbable water, more preferably less than about 8% desorbable water, and most preferably less than about 5% desorbable water. Such materials can be obtained by first activating/dehydrating by heating to about 150-350° C., optionally with reduced pressure (from about 0.001 to about 20 Torr), for at least about 12 hours. After activation, the perfume (or other agents) is slowly and thoroughly mixed with the activated zeolite. The perfume/zeolite mixture frequently generates heat and cooling of the materials during perfume incorporation is preferred. The perfume/zeolite mixture is then cooled to room temperature and kept for at least about 2 hours, to form a free-flowing powder.

Further, it is preferable to control humidity conditions throughout perfume incorporation, formulation of a perfume delivery composition and/or consumable composition, and packaging of the composition in order to maintain product performance and quality. Low ambient humidity of the process environment, before the consumable composition is packaged in a moisture impermeable container, is needed to keep the activated porous carriers from deactivating and potentially releasing the incorporated perfume prematurely. It is thus desirable to maintain the process environment at a relative humidity of less than about 50%, preferably less than about 40%, more preferably less than about 30%, and even more preferably less than about 20%.

The perfumed particles herein can optionally be coated with one or more protective layers, and agglomerated using, e.g., the coating material. Non-limiting examples of suitable coating materials include a coating matrix comprising polyols and/or diols as described in U.S. Pat. No. 5,691,303; a carbohydrate agglomerate or extrudate as disclosed in U.S. Pat. No. 5,648,328; a glassy coating comprising, e.g., starch hydrolysates, hydrogenated starch hydrolysates, sucrose, and glucose, as disclosed in U.S. Pat. No. 5,858,959; and a multiple coating including a glassy intermediate coating layer and a substantially non-tacky and/or non-sticky layer as described in U.S. Pat. No. 6,221,826. The perfumed particles herein can also optionally comprise a release barrier agent having cross-sectional area within the porous carrier being larger than the cross-sectional area of the pore openings of the porous carrier, as described in U.S. Pat. Nos. 6,048,830 and 6,245,732.

### CONSUMABLE COMPOSITIONS

The present invention also relates to solid consumable compositions comprising the perfume delivery composition, wherein said consumable composition is in a form selected from a powder, particles, granules, chips, noodles, tablet, sheet, and combinations thereof. The perfumed particles of the present invention can be used, e.g., as laundry additive particles to be added to the wash bath, rinse bath and/or drying cycle in an automatic clothes dryer. More preferably, the perfumed particles are incorporated into dry, solid consumable products, such as powder, granular detergent and/or fabric conditioning compositions, solid laundry detergent tablets, solid fabric conditioning tablets, fabric conditioning dryer sheets, insect repellent compositions, insecticidal compositions, air freshener compositions, carpet deodorizer compositions, and the like. Preferred consumable compositions of the present invention include compositions for single use comprising a perfume delivery composition, preferably being packaged in a moisture impermeable container. A preferred moisture impermeable container is a sealed film wrapper.

Detergent Compositions

A preferred consumable composition of the present invention is a solid laundry detergent. In a preferred embodiment, conventional laundry ingredients are admixed with the perfumed particles of the present invention to provide a solid detergent composition. The detergent compositions comprise from about 0.1% to about 50%, by weight of the composition of the perfumed particles and from about 40% to about 99.9% by weight of the detergent composition of detersive surfactant and one or more adjunct laundry ingredients. Preferred adjunct ingredients can be selected from the group consisting of builder, free perfume, bleaching agent, bleaching activator, bleach stabilizer, enzyme, enzyme stabilizing agent, soil release agent, soil-suspending agent, dye transfer inhibitor, fabric softening agent, static control agent, suds suppressor, suds booster, brightener, germicide, alkalinity source, hydrotrope, processing aid, antioxidant, solvent, dyes, color speckles, and mixtures thereof, and optionally other adjunct materials, preferably selected from the group consisting of dispersion agent, disintegration agent, solubilizing agent, binder, substrate, mold release agent, emulsifier, fillers, effervescent system, and mixtures thereof, that can aid in the manufacture, processing, dispensing, dispersing of the detergent compositions and the release of the laundry ingredients that they contain. The detergent composition comprises at least about 5%, preferably at least about 6%, more preferably at least about 8%, by weight of the detergent composition, of detersive surfactant. The laundry ingredients suitable for use in the present invention and/or non-limiting examples of detergent compositions, are disclosed with more details in U.S. Pat. No. 4,412,934 issued Nov. 1, 1983 to Chung, et al., U.S. Pat. No. 4,515,705 issued May 7, 1985 to Moeddel, U.S. Pat. No. 4,605,509 issued Aug. 12, 1986 to Corkill, et al., U.S. Pat. No. 5,415,807 issued May 16, 1995 to Gosselink, et al., U.S. Pat. No. 5,565,422 issued Oct. 15, 1996 to Del Greco, et al., U.S. Pat. No. 5,679,630 issued Oct. 21, 1997 to Baeck, et al., U.S. Pat. Nos. 6,048,830 and 6,245,732, PCT Publ. WO 01/85888 published Nov. 15, 2001 to Welch, et al.

A preferred solid laundry detergent composition is a powder, granular detergent composition which is preferably packaged in a moisture impermeable container that optionally has a resealable and/or reclosable opening.

In another preferred embodiment, the solid laundry detergent composition is designed for single use, and packaged in a moisture impermeable container or wrapper. The single use composition can be a powder, granular composition as described hereinabove. The single use composition can also be, e.g., a solid tablet, as being disclosed in, e.g., U.S. Pat. No. 5,360,567 issued Nov. 1, 1994 to Fry, et al., PCT Publication Nos. WO 00/66686, WO 00/66689-66691, WO 00/66693-66695, all published on Nov. 9, 2000, U.S. Pat No. 6,066,615 issued May 23, 2000 to Bijl, et al., U.S. Pat. No. 6,093,688 issued Jul. 25, 2000 to Gordon, U.S. Pat. No. 6,169,062 issued Jan. 2, 2001 to Salager, et al., and U.S. Pat. No. 6,313,080 issued Nov. 6, 2001 to Boskamp, et al. Optionally but preferably, detergent tablet composition comprises an effervescent system and/or a gas generating system as disclosed, e.g., in PCT Publ. WO 01/85888 published Nov. 15, 2001 to Welch, et al., and U.S. Pat. No. 6,274,538 issued Aug. 14, 2001 to Addison.

Fabric Conditioning Compositions

Another preferred consumable composition of the present invention is a solid fabric conditioning composition. In a preferred embodiment, conventional fabric conditioning ingredients are admixed with the perfumed particles of the present invention to provide a fabric conditioning composition. The fabric conditioning compositions comprise from about 0.1 % to about 50%, by weight of the fabric conditioning composition of the perfumed particles and from about 40% to about 99.9% by weight of the fabric conditioning composition of fabric softening agent and one or more adjunct fabric conditioning ingredients. Preferred adjunct ingredients can be selected from the group consisting of static control agent, free perfume, odor control agent, wrinkle control agent, fabric color maintenance agent, soil release agent, soil-suspending agent, dye transfer inhibitor, suds suppressor, suds booster, brightener, enzyme, germicide, insect repellent agent, hydrotrope, processing aid, antioxidant, dyes, and mixtures thereof, and optionally other adjunct materials selected from the group consisting of dispersion agent, disintegration agent, solubilizing agent, binder, substrate, mold release agent, emulsifier, fillers, effervescent system, and mixtures thereof that can aid in the manufacture, processing, dispensing, dispersing of the fabric conditioning compositions and the release of the fabric conditioning ingredients that they contain.

The solid fabric conditioning composition comprises at least about 5%, preferably at least about 6%, more preferably at least about 8%, by weight of the fabric conditioning composition, of fabric softening agent. The preferred fabric softening agent is selected from the group consisting of quaternary softening agent, amine softening agent, clay, silicones, and mixtures thereof, more preferably quaternary softening agent, amine softening agent, clay, and mixtures thereof. The fabric conditioning ingredients suitable for use in the present invention, and/or non-limiting examples of solid fabric conditioning compositions, are disclosed with more details in U.S. Pat. No. 4,855,072 issued Aug. 8, 1989 to Trinh, et al., U.S. Pat. No. 5,094,761 issued Mar. 10, 1992 to Trinh, et al., U.S. Pat. No. 5,545,340 issued Aug. 13, 1996, to Wahl, et al., U.S. Pat. No. 5,500,137 issued Mar. 19, 1996 and U.S. Pat. No. 5,505,866 issued Apr. 9, 1996, both to Bacon, et al., U.S. Pat. No. 5,476,599 issued Dec. 19, 1995 to Rushie, et al., U.S. Pat. No. 6,025,321 issued Feb. 15, 2000 to Smith, et al., U.S. Pat. No. 6,046,154 issued Apr. 4, 2000 to Trinh, et al., U.S. Pat. No. 6,313,080 issued Nov. 6, 2001 to Boskamp, et al., PCT Publication No. WO 00/24856 published May 4, 2000 to Barnabas, et al., U.S. Pat. No. 3,256,180 issued Jun. 14, 1966 to Weiss, U.S. Pat. No. 3,351,483 issued Nov. 7, 1967 to Miner, et al., U.S. Pat. No. 4,308,141 issued Dec. 29, 1981 to Cambre, U.S. Pat. No. 4,589,989 issued May 20, 1986 to Muller et al., U.S. Pat. No. 5,009,800 issued Apr. 23, 1991 to Foster, U.S. Pat. No. 5,232,612 issued Aug. 3, 1993 to Trinh, et al., and U.S. Pat. No. 5,545,350 issued Aug. 13, 1996 to Baker, et al.

In another preferred embodiment, the solid fabric conditioning composition is designed for single use, and packaged in a moisture impermeable container or wrapper. The single use composition can be in the form of a powder, granular, tablet, dryer sheet, and the like. When in the form of a tablet, the fabric conditioning composition optionally, but preferably comprises an effervescent system and/or a gas generating system as disclosed, e.g., PCT Publ. WO 01/85888 published Nov. 15, 2001 to Welch, et al., and U.S. Pat. No. 6,274,538 issued Aug. 14, 2001 to Addison.

Other Consumable Compositions

As noted above, the perfumed particles may be combined with other active materials to form scented solid consumable compositions. In addition to the detergent and fabric conditioning compositions described above, these consumable compositions can include insect repellent compositions, insecticidal compositions, air freshener compositions, carpet deodorizer compositions, and the like.

### ARTICLE OF MANUFACTURE

The present invention further relates to articles of manufacture comprising the perfume delivery compositions or solid consumable compositions described herein, preferably packaged in a moisture impermeable container that optionally has a reclosable or resealable opening. The perfumed particles comprise a selected perfume composition that is releasably incorporated into a solid, water insoluble, porous mineral carrier which include a number of pore openings, such as clay and zeolites.

The preferred container for use in the articles of the present invention is moisture impermeable optionally having a reclosable or resealable opening to allow the dispensing of the enclosed composition. Any of a variety of reclosable or resealable closure devices or means can be included to provide the container with a reclosable or resealable feature. Non-limiting examples of reclosable or resealable closure devices that are suitable for use in the present invention include twist cap, snap cap, mechanical clip, jeck-knife-type safety clip, clamp, tie string, tie strap, tongue and groove, and/or zippers.

The moisture impermeable container of the present invention can be a film container, such as a film bag or film pouch, a container comprising an outside support container and an internal film liner for containing the consumable composition, multilayer bag container having at least an inner liner bag and an outer support bag, or a container having a moisture impermeable, air tight, reclosable cap, preferably twist cap, wherein the cap can also be used as a measuring device for dispensing prescribed amounts of the consumable composition. Non-limiting examples of the preferred resealable film bags have zipper systems similar to those disclosed, e.g., in U.S. Pat. No. 5,007,143 issued Apr. 16, 1991, U.S. Pat. No. 5,010,627 issued Apr. 30, 1991, U.S. Pat. No. 5,063, 644 issued Nov. 12, 1991, U.S. Pat. No. 5,067,208 issued Nov. 26, 1991, U.S. Pat. No. 5,161,286 issued Nov. 10, 1992, U.S. Pat. No. 5,009,828 issued Apr. 23, 1991, U.S. Pat. No. 5,070,584 issued Dec. 10, 1991, U.S. Pat. No. 5,140,727 issued Aug. 25, 1992, U.S. Pat. No. 5,647,100 issued Jul. 15, 1997, and U.S. Pat. No. 5,867,875 issued Feb. 9, 1999. Non-limiting examples of resealable multilayer bag containers are those disclosed in U.S. Pat. No. 5,804,265 issued Sep. 8, 1998 to Saad, et al.

The film for use in the manufacture of the moisture impermeable container and wrapper can include extruded, cast, or blown films. The film can be a single layer or multiple laminated layers wherein each film layer is selected from the group consisting of polyester, nylon, polyethylene, polypropylene, cellulose ester, cellulose ether, polyvinyl alcohol acetal, polyvinyl chloride, polyvinyl chloride acetate, polystyral, methyl methacrylate, polyvinylidene chloride, ethylene octane copolymers, metallic foils such as aluminum foil, paper, and combinations thereof, and copolymers of these materials. Films made of polyester, metallized polyester, and laminates of polyester and metallized polyester are especially preferred.

The present invention also relates to articles of manufacture comprising solid consumable composition for single use comprising perfumed particles, wherein said consumable composition is packaged in a moisture impermeable container, preferably a moisture impermeable film container or wrapper. It also relates to articles of manufacture that comprises one or more single use compositions packaged in sealed, moisture impermeable film wrapper, in a package having a set of instructions associated with the container that directs the consumer to use said compositions to provide a long lasting perfume benefit.

The articles of manufacture of the present invention optionally comprise a set of instructions that directs the consumer to use said composition to provide a long lasting perfume benefit and/or to tightly reseal the container to preserve the long lasting perfume benefit. The set of instructions can comprise words, pictures, icons, and/or multi-lingual instructions. The instruction directing consumer to reclose the container tightly is important for preventing the ambient moisture from contacting the perfumed particles of the consumable composition, and from prematurely releasing the loaded perfume. The exclusion of ambient moisture from solid powder or granular consumable compositions, such as powder or granular detergent compositions, is beneficial in that it can keep the compositions in a free flowing state and minimize the agglomeration and caking of the composition, thus improving the dispensing of the compositions in use.

### METHODS OF MAKING THE COMPOSITIONS AND ARTICLES

The perfume delivery and solid consumable compositions of the present invention and articles of manufacture comprising the same, may be manufactured using conventional techniques and equipment. However, the selection and incorporation of a perfume composition into the porous mineral carrier during the preparation of the perfumed particles are essential features of such methods.

Specifically, the methods of the present invention include methods for selecting a perfume composition for incorporation into a porous carrier particle. Such methods comprise the step of obtaining a perfume composition comprising less than about 30%, preferably less than about 15%, more preferably less than about 8%, still more preferably less than about 6%, and even more preferably less than about 3%, by weight of the perfume composition, of unstable perfume ingredients, said unstable perfume ingredients having been described hereinabove. Furthermore, and as described in more detail above, it is preferable to control humidity conditions throughout perfume incorporation, the formulation of a perfume delivery composition and/or consumable composition, and the packaging of the composition in order to maintain product performance and quality. Low ambient humidity of the process environment, before the consumable composition is packaged in a moisture impermeable container, is needed to keep the activated porous carriers from deactivating and potentially releasing the incorporated perfume prematurely. It is thus desirable to maintain the process environment at a relative humidity of less than about 50%, preferably less than about 40%, more preferably less than about 30%, and even more preferably less than about 20%.

In addition, the methods of the present invention include methods for making a stable perfume delivery composition or a solid consumable composition. Such methods comprise the step of preparing or obtaining a perfume composition having less than about 30%, preferably less than about 15%, more preferably less than about 8%, still more preferably less than about 6%, and even more preferably less than about 3%, by weight of the perfume composition, of unstable perfume ingredients, said unstable perfume ingredients having been described hereinabove. The perfume composition is then incorporated into a solid, water insoluble, porous mineral carrier having a number of pore openings, preferably a clay and/or a zeolite, to form perfumed particles. Where a solid consumable composition is desired, the perfumed particles are combined with an active material to form a solid consumable composition. The solid consumable composition may be any solid consumable composition wherein the consumer expects or desires a fragrance, but is preferably selected from the group consisting of detergent compositions, fabric conditioning compositions, insect repellent compositions, insecticidal compositions, carpet deodorizing compositions and air freshening compositions.

The methods of the present invention further include methods for making articles of manufacture comprising the perfume delivery compositions or solid consumable compositions. Such methods comprise the steps of: a) selecting a perfume composition that has less than about 30%, preferably less than about 15%, more preferably less than about 8%, still more preferably less than about 6%, and even more preferably less than about 3%, by weight of the perfume composition, of unstable perfume ingredients; b) incorporating the perfume composition into a solid, water insoluble, porous mineral carrier, preferably a clay, and/or a zeolite, to form perfumed particles; c) optionally, combining the perfumed particles with an active material to form a solid consumable composition selected from the group consisting of detergent compositions, fabric conditioning compositions, insect repellent compositions, insecticidal compositions, carpet deodorizing compositions and air freshening compositions; and d) packaging the solid consumable composition in a moisture impermeable container. The containers for use in the articles of the present invention are described above, and in the case of containers for bulk compositions, preferably have a reclosable or resealable closure device or means.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A perfume delivery composition comprising perfumed particles, said perfumed particles comprising:
a) solid, water insoluble, porous mineral carrier, said carrier including a number of pore openings; and
b) perfume composition which is releasably incorporated in said carrier, to form a perfumed carrier;
wherein said perfume composition comprises less than about 30%, by weight of the perfume composition, of unstable perfume ingredients.

2. The composition of claim 1, wherein said perfume comprises less than about 15% by weight of the perfume composition, of said unstable perfume ingredients.

3. The composition of claim 2, wherein said perfume comprises less than about 6% by weight of the perfume composition, of said unstable perfume ingredients.

4. The composition of claim 1, wherein said perfume comprises at least about 85% by weight of the perfume composition, of stable perfume ingredients.

5. The composition of claim 4, wherein said perfume comprises at least about 93%, by weight of the perfume composition, of stable perfume ingredients.

6. The composition of claim 1, wherein said unstable perfume ingredient is selected from the group consisting of allylic alcohol ester, secondary alcohol ester, tertiary alcohol ester, allylic ketone, acetal, ketal, condensation product of amines and aldehydes, and mixtures thereof.

7. The composition of claims 1, wherein said carrier is selected from the group consisting of zeolite, clay, and mixtures thereof.

8. The composition of claim 7, wherein said clay is selected from the group consisting of smectite, bentonite, montmorillonite, kaolinite, metakaolin, attapulgite, and mixtures thereof.

9. The composition of claim 7, wherein said zeolite comprises natural or synthetic zeolite having a nominal pore size of at least about 6 Angstroms.

10. The composition of claim 7, wherein said zeolite has a particle size no larger than about 120 microns.

11. The composition of claims 5, wherein said zeolite is Zeolite X or Zeolite Y.

12. The composition of claims 5, wherein said zeolite is dehydrated or activated zeolite.

13. The composition of claim 1, wherein said perfumed carrier comprises from about 5% to about 30%, of said perfume.

14. The composition of claim 6, wherein said allylic alcohol ester is selected from the group consisting of allyl amyl glycolate, allyl anthranilate, allyl benzoate, allyl butyrate, allyl caprate, allyl caproate, allyl cinnamate, allyl cyclohexane acetate, allyl cyclohexane butyrate, allyl cyclohexane propionate, allyl heptoate, allyl nonanoate, allyl salicylate, amyl cinnamyl acetate, amyl cinnamyl formate, cinnamyl formate, cinnamyl acetate, cyclogalbanate, geranyl acetate, geranyl acetoacetate, geranyl benzoate, geranyl cinnamate, methallyl butyrate, methallyl caproate, neryl acetate, neryl butyrate, amyl cinnamyl formate, alpha-methyl cinnamyl acetate, methyl geranyl tiglate, mertenyl acetate, farnesyl acetate, fenchyl acetate, geranyl anthranilate, geranyl butyrate, geranyl iso-butyrate, geranyl caproate, geranyl caprylate, geranyl ethyl carbonate, geranyl formate, geranyl furoate, geranyl heptoate, geranyl methoxy acetate, geranyl pelargonate, geranyl phenylacetate, geranyl phthalate, geranyl propionate, geranyl iso-propoxyacetate, geranyl valerate, geranyl iso-valerate, trans-2-hexenyl acetate, trans-2-hexenyl butyrate, trans-2-hexenyl caproate, trans-2-hexenyl phenylacetate, trans-2-hexenyl propionate, trans-2-hexenyl tiglate, trans-2-hexenyl valerate, beta-pentenyl acetate, alpha-phenyl allyl acetate, prenyl acetate, trichloromethylphenylcarbinyl acetate, amyl vinyl carbinyl acetate, amyl vinyl carbinyl propionate, hexyl vinyl carbinyl acetate, 3-nonenyl acetate, 4-hydroxy-2-hexenyl acetate, linallyl anthranilate, linallyl benzoate, linallyl butyrate, linallyl iosbutyrate, linallyl carproate, linallyl caprylate, linallyl cinnamate, linallyl citronellate, linallyl formate, linallyl heptoate, linallyl-N-methylanthranilate, linallyl methyltiglate, linallyl pelargonate, linallyl phenylacetate, linallyl propionate, linallyl pyruvate, linallyl salicylate, linallyl-n-valerate, linallyl-iso-valerate, myrtenyl acetate, nerolidyl acetate, nerolidyl butyrate, beta-pentenyl acetate, alpha-phenyl allyl acetate, and mixtures thereof; wherein said secondary alcohol ester is selected from the group consisting of secondary-n-amyl acetate, ortho-tertiary-amyl cyclohexyl acetate, isoamyl benzyl acetate, secondary-n-amyl butyrate, amyl vinyl carbinyl acetate, amyl vinyl carbinyl propionate, cyclohexyl salicylate, dihydro-nor-cyclopentadienyl acetate, dihydro-nor-cyclopentadienyl propionate, isobornyl acetate, isobornyl salicylate, isobornyl valerate, flor acetate, frutene, 2-methylbuten-2-ol-4-acetate, methyl phenyl carbinyl acetate, 2-methyl-3-phenyl propan-2-yl acetate, prenyl acetate, 4-tert-butyl cyclohexyl acetate, 2-tert-butyl cyclohexyl acetate, 4-tert-butylcyclohexyl acetate, carbonic acid 4-cycloocten-1-yl methyl ester, ethenyl-iso-amyl carbinylacetate, fenchyl acetate, fenchyl benzoate, fenchyl-n-butyrate, fenchyl isobutyrate, laevo-menthyl acetate, dl-menthyl acetate, menthyl anthranilate, menthyl benzoate, menthyl-iso-butyrate, menthyl formate, laevo-menthyl phenylacetate, menthyl propionate, menthyl salicylate, menthyl-iso-valerate, cyclohexyl acetate, cyclohexyl anthranilate, cyclohexyl benzoate, cyclohexyl butyrate, cyclohexyl-iso-butyrate, cyclohexyl caproate, cyclohexyl cinnamate, cyclohexyl formate, cyclohexyl heptoate, cyclohexyl oxalate, cyclohexyl pelargonate, cyclohexyl phenylacetate, cyclohexyl propionate, cyclohexyl thioglycolate, cyclohexyl valerate, cyclohexyl-iso-valerate, methyl amylacetate, methyl benzyl carbinyl acetate, methyl butyl cyclohexanyl acetate, 5-methyl-3-butyl-tetrahydropyran-4-yl acetate, methyl citrate, methyl-iso-campholate, 2-methyl cyclohexyl acetate, 4-methyl cyclohexyl acetate, 4-methyl cyclohexyl methyl carbinyl acetate, methyl ethyl benzyl carbinyl acetate, 2-methylheptanol-6-acetate, methyl heptenyl acetate, alpha-methyl-n-hexyl carbinyl formate, methyl-2-methylbutyrate, methyl nonyl carbinyl acetate, methyl phenyl carbinyl acetate, methyl phenyl carbinyl anthranilate, methyl phenyl carbinyl benzoate, methyl phenyl carbinyl-n-butyrate, methyl phenyl carbinyl-iso-butyrate, methyl phenyl carbinyl caproate, methyl phenyl carbinyl caprylate, methyl phenyl carbinyl cinnamate, methyl phenyl carbinyl formate, methyl phenyl carbinyl phenylacetate, methyl phenyl carbinyl propionate, methyl phenyl carbinyl salicylate, methyl phenyl carbinyl-iso-valerate, 3-nonanyl acetate, 3-nonenyl acetate, nonane diol-2:3-acetate, nonynol acetate, 2-octanyl acetate, 3-octanyl acetate, n-octyl acetate, secondary-octyl-iso-butyrate, beta-pentenyl acetate, alpha-phenyl allyl acetate, phenylethyl methyl carbinyl-iso-valerate, phenylethyleneglycol diphenylacetate, phenylethyl ethnyl carbinyl acetate, phenylglycol diacetate, seconday-phenylglycol monoacetate, phenylglycol monobenzoate, isopropyl caprate, isopropyl caproate, isporppyl caprylate, isopropyl cinnamate, para-isopropyl cyclohexanyl acetate, propylglycol diacetate, propyleneglycol di-isobutyrate, propyleneglycol dipropionate, isopropyl-n-heptoate, isopropyl-n-hept-1-yne carbonate, isopropyl pelargonate, isopropyl propionate, isopropyl undecylenate, isopropyl-n-valerate, isopropyl-n-valerate, isopropyl-iso-valerate, isopropyl sebacinate, isopulegyl acetate, isopulegyl acetoacetate, isopulegyl isobutyrate, isopulegyl formate, thymyl propionate, alpha-2,4-trimethyl cyclohexane methylacetate, trimethyl cyclohexyl acetate, vanillin triacetate, vanillylidene diacetate, vanillyl vanillate, and mixtures thereof; wherein said tertiary alcohol ester is selected from the group consisting of tertiary-amyl acetate, caryophyllene acetate, cedrenyl acetate, cedryl acetate, dihydromyrcenyl acetate, dihydroterpinyl acetate, dimethyl benzyl carbinyl acetate, dimethyl benzyl carbinyl isobutyrate, dimethyl heptenyl acetate, dimethyl heptenyl formate, dimethyl heptenyl propionate, dimethyl heptenyl-iso-butyrate, dimethyl phenylethyl carbinyl acetate, dimethyl phenylethyl carbinyl-iso-butyrate, dimethyl phenylethyl carbinyl-iso-valerate, dihydro-nor-dicyclopentadienyl acetate, dimethyl benzul carbinyl butyrate, dimethyl benzyl carbinyl formate, dimethyl benzyl carbinyl propionate, dimethyl phenylethyl carbinyl-n-butyrate, dimethyl phenyletyl carbinyl formate, dimethyl phenylethyl carbinyl propionate, elemyl acetate, ethinyl cyclohexylacetate, eudesmyl acetate, eugenyl cinnamate, eugenyl formate, iso-eugenyl formate, eugenyl phenylacetate, isoeudehyl phenylacetate, guaiyl acetate, hydroxycitronellyl ethylcarbonate, linallyl acetate, linallyl anthranilate, linallyl benzoate, linallyl butyrate, linallyl iosbutyrate, linallyl carproate, linallyl caprylate, linallyl cinnamate, linallyl citronellate, linallyl formate, linallyl heptoate, linallyl-N-methylanthranilate, linallyl methyltiglate, linallyl pelargonate, linallyl phenylacetate, linallyl propionate, linallyl pyruvate, linallyl salicylate, linallyl-n-valerate, linallyl-iso-valerate, methylcyclopentenolone butyrate, methyl cyclopentenolone propionate, methyl ethyl phenyl carbinyl acetate, methyl heptin carbonate, methyl nicotinate, myrcenyl acetate, myrcenyl formate, myrcenyl propionate, cis-ocimenyl acetate, phenyl salicylate, terpinyl acetate, terpinyl anthranilate, terpinyl benzoate, terpinyl-n-butyrate, terpinyl-iso-butyrate, terpinyl cinnamate, terpinyl formate, terpinyl phenylacetate, terpinyl propionate, terpinyl-n-valerate, terpinyl-iso-valerate, tributyl acetylcitrate, and mixtures thereof; wherein said allylic ketone is selected from the group consisting of acetyl furan, allethrolone, allyl ionone, allyl pulegone, amyl cyclopentenone, benzylidene acetone, benzylidene acetophenone, alpha iso methyl ionone, 4-(2,6,6-trimetyl-1-cyclohexen-1-yl)-3-buten-2-one, beta damascone (1-(2,6,6-trimethylcyclohexen-1-yl)-2-buten-1-one), damascenone (1-(2,6,6-trimethyl-1,3-cyclohexadien-1-yl)-2-buten-1-one), delta damascone (1-(2,6,6-trimethyl-3-cyclo-hexen-1-yl)-2-buten-1-one), alpha ionone (4-(2,6,6-trimethyl-1-cyclohexenyl-1-yl)-3-buten-2-one), beta ionone (4-(2,6,6-trimethyl-1-cyclohexen-1-yl)-3-butene-2-one), gamma methyl ionone (4-(2,6,6-trimethyl-2-cyclohexyl-1-yl)-3-methyl-3-buten-2-one), pulegone, and mixtures thereof; wherein said acetal is selected from the group consisting of acetaldehyde-benzyl-beta-methoxyethyl acetal, acetaldehyde-di-iso-amyl acetal, acetaldehyde-di-pentandeiol acetal, acetaldehyde-di-n-propyl acetal, 10 acetaldehyde-ethyl-trans-3-hexenyl acetal, acetaldehyde-phenylethyleneglycol acetal, acetaldehyde phenylethyl-n-propylacetal, cinnamic aldehyde dimethyl acetal, acetaldehyde-benzyl-beta-methoxyethyl acetal, acetaldehyde-di-iso-amylacetal, acetaldehyde diethylacetal, acetaldehyde-di-cis-3-hexenyl acetal, acetaldehyde-di pentanediol acetal, acetaldehyde-di-n-propyl acetal, acetaldehyde-ethyl-trans-3-hexenyl acetal, acetaldehyde-phenylethyleneglycol acetal, acetaldehyde phenylethyl-n-propylacetal, acetylvanillin dimethylacetal, alpha-amylcinnamic aldehyde-di-iso-propyl acetal, p-tertiary-amyl phenoxy acetaldehyde diethylacetal, anisaldehyde-diethylacetal, anisaldehyde-dimethylacetal, iso-apiole, benzaldehyde diethylacetal, benzaldehyde-di-(ethyleneglycol monobutylether) acetal, benzaldehyde dimethylacetal, benzaldehyde ethyleneglycolacetal, benzaldehyde glyceryl acetal, benzaldehydepropyleneglycol acetal, cinnamic aldehyde diethyl acetal, citral diethyl acetal, citral dimethyl acetal, citral propyleneglycol acetal, alpha-methylcinnamic aldehyde diethylacetal, alpha-cinnamic aldehyde dimethylacetal, phenylacetaldehyde-2,3-butyleneglycol acetal, phenylacetaldehyde citronellyl methyl acetal, phenylacetaldehyde diallylacetal, phenylacetaldehyde diamylacetal, phenylacetaldehyde dibenzylacetal, phenylacetaldehyde dibutyl acetal, phenylacetaldehyde diethylacetal, phenylacetaldehyde digeranylacetal, phenylacetaldehyde dimethylacetal, phenylacetaldehyde ethyleneglycol acetal, phenylacetalde glycerylacetal, citronellal cyclomonoglycolacetal, citronellal diethylacetal, citronellal dimethylacetal, citronellal diphenylethyl acetal, geranoxyacetaldehyde diethylacetal, and mixtures thereof; wherein said ketal is selected from the group consisting of acetone diethylkatal, acetone dimethylketal, acetophenone diethyl ketal, methyl amyl catechol ketal, methyl butyl catechol ketal, and mixtures thereof; and wherein said condensation product of amine and aldehyde is selected from the group consisting of anisaldehyde-methylanthranilate, hydroxycitronellal methylanthranilate, 4-tert-butyl-alpha-methyldihydrocinnamaldehyde methyl anthranilate, 2,4-dimethyl-3-cyclohexene carbaldehyde, hydroxycitronellal ethylanthranilate, hydroxycitronellal linallylanthranilate, methyl-N-(4-(4-hydroxy-4-methylpentyl)-3-cyclohexenyl-methylidene)-anthranilate, methylnaphthylketone-methylanthranilate, methyl nonyl acetaldehyde methylanthranilate, methyl-N-(3,5,5-trimethylhexylidene) anthranilate, vanillin methylanthranilate, and mixtures thereof.

15. The composition of claim 1, wherein said perfume composition comprises at least about 6 perfume ingredients.

16. The composition of claim 1, wherein said perfume composition comprises at least about 30%, of perfume ingredients having a boiling point being equal or lower than about 250° C. and/or a ClogP being equal or smaller than about 3.0.

17. The composition of claim 16, wherein the perfume ingredient is selected from the group consisting of amyl acetate, amyl propionate, anethol, anisic aldehyde, anisole, benzaldehyde, benzyl acetate, benzyl acetone, benzyl alcohol, benzyl butyrate, benzyl formate, benzyl iso valerate, benzyl propionate, camphor gum, carvacrol, laevo-carveol, d-carvone, laevo-carvone, citral (neral), citronellol, citronellyl acetate, citronellyl isobutyrate, citronellyl nitrile, citronellyl propionate, para-cresol, para-cresyl methyl ether, cyclohexyl ethyl acetate, cuminic alcohol, cuminic aldehyde, cyclal C (3,5-dimethyl-3-cyclohexene-1-carboxaldehyde), para-cymene, decyl aldehyde, dimethyl benzyl carbinol, dimethyl octanol, diphenyl oxide, dodecalactone, ethyl acetate, ethyl aceto acetate, ethyl amyl ketone, ethyl benzoate, ethyl butyrate, ethyl hexyl ketone, ethyl phenyl acetate, eucalyptol, eugenol, fenchyl alcohol, geraniol, geranyl nitrile, hexenol, beta gamma hexenol, hexenyl acetate, cis-3-hexenyl acetate, hexenyl isobutyrate, cis-3-hexenyl tiglate, hexyl acetate, hexyl formate, hexyl neopentanoate, hexyl tiglate, hydratropic alcohol, hydroxycitronellal, indole, alpha-irone, isoamyl alcohol, isobutyl benzoate, isomenthone, isononyl acetate, isononyl alcohol, isobutyl quinoline, isomenthol, para-isopropyl phenylacetaldehyde, isopulegol, isopulegyl acetate, isoquinoline, cis-jasmone, lauric aldehyde (dodecanal), ligustral (2,4-dimethyl-3-cyclohexene-1-carboxaldehyde), linalool, linalool oxide, menthone, methyl acetophenone, para-methyl acetophenone, methyl amyl ketone, methyl anthranilate, methyl benzoate, methyl benzyl acetate, methyl chavicol, methyl eugenol, methyl heptenone, methyl heptine carbonate, methyl heptyl ketone, methyl hexyl ketone, methyl nonyl acetaldehyde, methyl octyl acetaldehyde, methyl salicylate, myrcene, neral, nerol, gamma-nonalactone, nonyl acetate, nonyl aldehyde, allo-ocimene, octalactone, octyl alcohol (octanol-2), octyl aldehyde, (d-limonene), phenoxy ethanol, phenyl acetaldehyde, phenyl ethyl acetate, phenyl ethyl alcohol, phenyl ethyl dimethyl carbinol, propyl butyrate, rose oxide, 4-terpinenol, alpha-terpineol, terpinolene, tonalid (6-acetyl-1,1,3,4,4,6-hexamethyl tetrahydronaphthalene), undecenal, veratrol (ortho-dimethoxybenzene), coumarin, dihydroeuginol, dihydro isojasmonate, ethyl cinnamate, ethyl maltol, ethyl-2-methyl butyrate, ethyl salicylate, ethyl vanillin, eugenyl acetate, eugenyl formate, eugenyl methyl ether, fructone, geranyl oxyacetaldehyde, heliotropin, hinokitiol, hydroxycitronellol, indole, isoeugenol, isoeugenyl acetate, isomenthone, lyral, methyl cinnamate, methyl dihydrojasmonate, methyl isobutenyl tetrahydropyran, methyl beta naphthyl ketone, para-anisic aldehyde, para hydroxy phenyl butanone, para-methoxy acetophenone, para methyl acetophenone, phenoxyethyl propionate, phenylacetaldehyde diethyl ether, phenylethyl oxyacetaldehyde, vanillin, and mixtures thereof.

18. The composition of claim 1, wherein said perfume composition additionally comprises 1,5,5,9-tetramethyl-1,3-oxatricyclotridecane, anethole, 2-ethyl-4-(2,2,3-trimethyl-3-cyclopenten-1-yl)-2-buten-1-ol, benzyl acetone, benzyl salicylate, butyl anthranilate, calone, 2-ethyl-4-(2,2,3-trimethyl-3-cyclopenten-1-yl)-2-buten-1-ol, cinnamic alcohol, coumarin, 3,5-dimethyl-3-cyclohexene-1-carboxaldehyde, 2-methyl-3-(para iso propylphenyl)propionaldehyde, 4-decenal, dihydro isojasmonate, gamma-dodecalactone, ebanol, ethyl anthranilate, ethyl-2-methyl butyrate, ethyl vanillin, eugenol, florhydral (3-(3-isopropylphenyl)butanol), fructone (ethyl-2-methyl-1,3-dioxolane-2-acetate), heliotropin, 3,3,5-trimethylcyclohexyl-ethyl ether, cis-3-hexenyl salicylate, indole, iso cyclo citral, isoeugenol, alpha-isomethylionone, keone, para-tertiary butyl alpha-methyl hydrocinnamic aldehyde, linalool, 4-(4-hydroxy-4-methyl-pentyl)3-cylcohexene-1-carboxaldehyde, methyl heptine carbonate, methyl anthranilate, methyl dihydrojasmonate, methyl isobutenyl tetrahydropyran, methyl beta naphthyl ketone, methyl nonyl ketone, beta naphthol methyl ether, nerol, para-anisic aldehyde, para hydroxy phenyl butanone, phenyl acetaldehyde, gamma-undecalactone, undecylenic aldehyde, vanillin, and mixtures thereof.

19. The composition of claim 1, wherein said perfume composition comprises less than about 45%, by weight of the perfume composition of terpinol, or wherein said perfume composition comprises less than about 100% aldehyde and/or acetal perfume ingredients, or wherein said perfume composition does not consist of 0.2% allyl amyl glycolate, 0.31% damascenone, 0.51% decyl aldehyde, 15.27% dihydro iso jasmonate, 1.02% helional, 14.97% ionone gamma methyl, 20.37% linalool, 1.02% myrcene, 15.27% p.t. bucinal, 0.51% para methyl acetophenone, 20.37% phenyl ethyl alcohol, and 10.18% undecavertol, or wherein said perfume composition does not consist of 10% benzyl salicylate, 5% coumarin, 2% ethyl vanillin, 10% ethylene brassylate, 15% galaxolide, 20% hexyl cinnamic aldehyde, 10% gamma methyl ionone, 15% lilial, 5% methyl dihydrojasmonate, 5% patchouli, and 3% tonalid.

20. The composition of claim 1, wherein the particles are coated with one or more protective layers.

21. The composition of claim 1, wherein the particles are agglomerated and/or granulated.

22. The composition of claim 1, wherein the perfume particles further comprise the encapsulation of the perfume composition in a form selected from the group consisting of molecular encapsulation, coacervate microencapsulation, matrix encapsulation and mixtures thereof.

23. A solid consumable composition comprising the composition of claim 1, wherein said consumable composition is in the form selected from powder, particles, granules, chips, noodles, tablet, sheet, and combinations thereof.

24. The consumable composition of claim 23, wherein the composition is designed for single use.

25. The consumable composition of claim 24, wherein the composition is a detergent composition.

26. The consumable composition of claim 23, comprising from about 0.01% to about 50% by weight of the detergent composition of perfumed particles, and from about 40% to about 99.99% by weight of the detergent composition of laundry ingredients comprising at least about 5% by weight of the detergent composition of detersive surfactant, and one or more adjunct ingredients selected from the group consisting of builder, free perfume, pro-fragrance, perfume microcapsule, bleaching agent, bleaching activator, bleach stabilizer, enzyme, enzyme stabilizing agent, soil release agent, soil suspending agent, dye transfer inhibitor, fabric softening agent, static control agent, suds suppressor, suds booster, brightener, germicide, alkalinity source, hydrotrope, antioxidant, solvent, dyes, color speckles, and mixtures thereof.

27. The consumable composition of claim 26, additionally comprising adjunct materials selected from the group consisting of dispersion agent, disintegration agent, solubilizing agent, processing aid, binder, substrate, mold release agent, emulsifier, fillers, effervescent system and/or gas generating system, and mixtures thereof.

28. The consumable composition of claim 23, wherein the composition is a powder, granular fabric conditioning composition.

29. The consumable composition of 23, wherein the composition is a solid fabric conditioning composition comprising from about 0.1% to about 50%, by weight of the fabric conditioning composition of the perfumed particles and from about 40% to about 99.9% by weight of the fabric conditioning composition of fabric conditioning ingredients comprising at least about 5% by weight of the fabric conditioning composition of fabric softening agent, and one or more adjunct fabric conditioning ingredients selected from the group consisting of static control agent, free perfume, pro-fragrance, perfume microcapsule, wrinkle control agent, fabric color maintenance agent, soil release agent, soil-suspending agent, dye transfer inhibitor, suds suppressor, suds booster, brightener, enzyme, germicide, insect repellent agent, hydrotrope, processing aid, antioxidant, dyes, and mixtures thereof.

30. The composition of claim 29, additionally comprising adjunct materials selected from the group consisting of dispersion agent, disintegration agent, solubilizing agent, processing aid, binder, substrate, mold release agent, emulsifier, fillers, effervescent system and/or gas generating system, and mixtures thereof.

31. The consumable composition of claim 23, wherein the consumable composition is selected from the group consisting of insect repellent compositions, insecticidal compositions, carpet deodorizing compositions and air freshening compositions.

32. An article of manufacture comprising a composition of claim 1, wherein said composition is packaged in a moisture impermeable container.

33. The article of claim 32, wherein said container comprises a re-sealable or re-closable opening, and further comprising a cap for re-sealing or re-closing said opening.

34. The article of claim 33, wherein said cap comprises a measuring device for use to dispense prescribed amounts of the consumable composition.

35. The article of claim 32, wherein said container comprises a film.

36. The article of claim 32, wherein said container comprises an outer package and a resealable film liner containing the consumable composition.

37. The article of claim 35, wherein said film is a single layer or multiple laminated layers wherein each film layer is selected from the group consisting of polyester, nylon, polyethylene, polypropylene, cellulose ester, cellulose ether, polyvinyl alcohol acetal, polyvinyl chloride, polyvinyl chloride acetate, polystyral, methyl methacrylate, polyvinylidene chloride, ethylene octane copolymers, metallic foil, paper, and copolymers thereof, and mixtures thereof.

38. The article of manufacture of claim 32, further comprising a set of instructions in association with the container, said set of instructions directing the consumer to use said composition to provide a long lasting perfume benefit and/or to tightly reseal the container to preserve the long lasting perfume benefit.

39. An article of manufacture comprising a composition of claim 1 in a package, said package having a set of instructions for use which directs the consumer to use said composition to provide a long lasting perfume benefit.

40. A method of making a perfume delivery composition or a solid consumable composition, the method comprising the steps of:
a) selecting a perfume composition, said perfume composition comprising less than about 30%, by weight of the perfume composition, of unstable perfume ingredients;
b) incorporating said perfume composition into a solid, water insoluble, porous mineral carrier, said carrier including a number of pore openings to form a perfumed particle; and
c) optionally, combining the perfumed particle with an active material to form a consumable composition selected from the group consisting of detergent compositions, fabric conditioning compositions, insect repellent compositions, insecticidal compositions, carpet deodorizing compositions and air freshening compositions.

41. The method of claim 40, wherein relative humidity conditions of the process environment are maintained below about 50% RH.

42. The method of claim 40, wherein said perfume comprises less than about 15%, by weight of the perfume composition, of said unstable perfume ingredients.

43. A method of making an article of manufacture, the method comprising the steps of:
a) selecting a perfume composition, said perfume composition comprising less than about 30%, by weight of the perfume composition, of unstable perfume ingredients;
b) incorporating said perfume composition into a solid, water insoluble, porous mineral carrier, said carrier including a number of pore openings to form a perfumed particle;
c) optionally, combining the perfumed particle with an active material to form a solid consumable composition selected from the group consisting of detergent compositions, fabric conditioning compositions, insect repellent compositions, insecticidal compositions, carpet deodorizing compositions and air freshening compositions; and
d) packaging the solid consumable composition in a moisture impermeable container.
